(19) United States
(12) Patent Application Publication
(10) Pub. No.: US 2025/0085134 A1
(43) Pub. Date: Mar. 13, 2025

(54) Detailed Destination Information During a Navigation Session

(71) Applicant: GOOGLE LLC, Mountain View, CA (US)

(72) Inventor: Matthew Sharifi, Mountain View, CA (US)

(21) Appl. No.: 18/564,853

(22) PCT Filed: Dec. 28, 2022
(86) PCT No.: PCT/US22/54173

§ 371 Date: Nov. 28, 2023

(51) Int. Cl. G01C 21/36; G06F 12/0802

(52) U.S. Cl. CPC G01C 21/3682; G06F 12/0802; G06F 2212/60

(57) ABSTRACT

To provide detailed destination information during a navigation session, a computing device receives a request for navigation directions to a point of interest (POI), and provides a set of navigation directions for traveling along a route to the POI for display to a user in a navigation session. The computing device obtains web content regarding the POI from a website for the POI. During the navigation session as the user travels to the POI, the computing device provides information to the user regarding the obtained web content.

### FIELD OF THE DISCLOSURE

The present disclosure generally relates to providing detailed destination information during a navigation session, such as information about the menu at a restaurant as the user is traveling to the restaurant.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Today, many users request map and navigation data for various geographic locations. Software applications executing in computers, smartphones, embedded devices, etc., generate step-by-step navigation directions in response to receiving input from a user, specifying the starting point and the destination. The navigation directions are typically generated for a route which guides the user to the destination in the shortest amount of time.

### SUMMARY

In some scenarios, a user may want more specific information about their destination location, which may be a point of interest (POI). For example, the user may want to know menu items at the restaurant where they are having dinner, ride information at an amusement park, showtimes at a movie theater, etc. To provide detailed destination information during a navigation session, a detailed information navigation system maps places or POIs to corresponding websites. For example, the detailed information navigation system may map the place, Jack's Burgers, to the website www.jacksburgers.com. Then the detailed information navigation system analyzes web content on a website mapped to a particular POI to provide the detailed destination information for the particular POI.

In some implementations, the detailed information navigation system stores links to websites corresponding to each POI. Then when the user requests navigation directions to a particular POI, the detailed information navigation system retrieves web content at the stored link. In other implementations, the detailed information navigation system caches the web content in a database, where the web content is stored in association with the corresponding POI. The detailed information navigation system may then periodically obtain updates to the web content each hour, each day, each week, etc.

In any event, when a user provides a request for navigation directions to a particular POI, the detailed information navigation system generates a set of navigation directions for traveling to the POI. The detailed information navigation system also analyzes the web content to identify an announcement included in the web content, such as that a particular ride is out of order, that a particular menu item is new or sold out, etc. Additionally, the detailed information navigation system may compare information from the web content to information from the previous time the user traveled to the particular POI. If the information changed since the previous time the user traveled to the particular POI, the detailed information navigation system may include the changed information in an announcement.

Additionally, the user may provide a query regarding the particular POI, such as “Tell me about the items on the menu.” The detailed information navigation system may then analyze the web content for the particular POI to identify menu items included on the POI's website. Then the detailed information navigation system may provide a response to the user's query using the menu items identified in the web content.

In this manner, the detailed information navigation system provides information about a destination during a navigation session as the user is traveling to the destination. This improves the user experience by not only providing the user with directions to a destination, but also real-time or near real-time information about activities, events, entertainment, menu items, etc. at the destination. Additionally, by identifying a particular website or web page that corresponds to a particular POI and storing a link to the particular website or web page and/or caching web content from the particular website or web page in association with the particular POI, the detailed information navigation system does not have to repeatedly crawl the Internet to identify the same POI website. Instead, the detailed information navigation system may populate an indication of the particular POI in a POI database with a link to the corresponding website or web page the first time a user requests directions to the POI or before users request directions to the POI. Then when the user requests directions to the POI a subsequent time or when a different user requests directions to the POI, the detailed information navigation system may retrieve the web content from the stored link or may have already cached the web content which is up to date.

The present disclosure combines the provision of navigation directions to a destination with the provision of detailed information regarding the destination. A computing device, such as a server, may first receive a request for navigation directions to a POI and may provide navigation directions to the POI. Subsequently, if the computing device receives a query or request for information, the computing device can use the context that a user is navigating to the POI to resolve the query or request more efficiently. For example, the computing device may constrain the index of web pages searched for the information to pages associated with the POI. This may lower the processing power required to satisfy the query or request through reducing the number of web pages that need to be accessed and/or parsed.

The present disclosure enables information regarding the POI to be provided in an integrated manner with the navigation directions. The information can be provided within the navigation application or navigation session providing the navigation directions. This can be more efficient than requiring the user to open a different application such as a web browser. Because the information can be provided within the navigation application, a user computing device need not allocate memory to additionally running a different application such as a web browser, which may make more efficient use of available computational resources.

Moreover, because the POI is already known to the navigation application, and may not be known to a different application, satisfying subsequent queries/requests can be more efficient when the provision of navigation directions and the provision of detailed information is integrated. The present disclosure enables information to be identified and/or downloaded before a query or request for that information is received. For example, when a request for navigation directions to a POI is received, a computing device may download/cache/store information from one or more web pages associated with the POI. Subsequently, upon receiving a query or request for information regarding the POI, the computing device can parse the downloaded/cached/stored information and respond based on these. In other words, this enables relevant information to be effectively pre-fetched, which enables a faster and more efficient response to the query or request to be provided. This downloading/caching/storing of information from the time when the navigation directions are requested may prevent issues relating to loss of signal/connection at later times when a query or request is received, since relevant information will already have been made available.

In addition, it may enable overall use of available bandwidth to be smoothed out, for example via downloading/caching/storing of the information at a time of otherwise low overall bandwidth usage. In some examples, the information may be downloaded/cached/stored at a user computing device (e.g., in a web content database of the user computing device). This local storage of the information may further reduce negative impacts of any poor connectivity while the user is navigating to the POI.

One example embodiment of the techniques of this disclosure is a method for providing detailed destination information during a navigation session. The method includes receiving a request for navigation directions to a point of interest (POI), and providing, for display to a user in a navigation session, a set of navigation directions for traveling along a route to the POI. The method further includes obtaining web content regarding the POI from a website for the POI. During the navigation session as the user travels to the POI, the method includes providing information to the user regarding the obtained web content.

Another example embodiment is a computing device for providing detailed destination information during a navigation session. The computing device includes one or more processors, and a computer-readable memory, which is optionally non-transitory, coupled to the one or more processors and storing instructions thereon. When executed by the one or more processors, the instructions cause the computing device to provide, for display to a user in a navigation session, a set of navigation directions for traveling along a route to a point of interest (POI), and obtain web content regarding the POI from a website for the POI. During the navigation session as the user travels to the POI, the instructions cause the computing device to provide information to the user regarding the obtained web content.

Yet another example embodiment is a computer-readable medium, which is optionally non-transitory, storing instructions thereon. The instructions, when executed by one or more processors cause the one or more processors to provide, for display to a user in a navigation session, a set of navigation directions for traveling along a route to a point of interest (POI), and obtain web content regarding the POI from a website for the POI. During the navigation session as the user travels to the POI, the instructions cause the one or more processors to provide information to the user regarding the obtained web content.

### BRIEF DESCRIPTION OF THE DRAWINGS

FIG. 1 is a block diagram of an example communication system in which techniques for providing detailed destination information during a navigation session can be implemented;

FIG. 2 illustrates an example scenario within a vehicle interior where a user requests navigation directions to a POI and the navigation application provides the navigation directions with an announcement regarding the POI, where the announcement includes detailed information about the POI;

FIG. 3 illustrates another example scenario within a vehicle interior where a user provides a query regarding detailed information about a POI as the user is traveling to the POI, and the navigation application provides a response to the query by obtaining web content from a POI website;

FIG. 4 illustrates yet another example scenario within a vehicle interior where the user provides an additional query for further information regarding the POI as the user is traveling to the POI, and the navigation application provides a response to the query by obtaining web content from a POI website;

FIG. 5 illustrates another example scenario within a vehicle interior where a user provides a query for current information about a POI as the user is traveling to the POI, and the navigation application provides a response to the query with the current information by obtaining web content from a POI website;

FIG. 6 illustrates an example scenario within a vehicle interior where a user requests navigation directions to a POI and the navigation application provides the navigation directions with an announcement indicating changes since the user last visited the POI;

FIG. 7 illustrates yet another example scenario within a vehicle interior where a user provides a query regarding detailed information about a POI as the user is traveling to the POI, and the navigation application provides a response to the query along with an announcement for the POI; and

FIG. 8 is a flow diagram of an example method for providing detailed destination information during a navigation session, which can be implemented in a computing device, such as the server device of FIG. 1.

### DETAILED DESCRIPTION

### Overview

Generally speaking, the techniques of this disclosure include a user computing device, a vehicle computing device, and/or one or more network servers. However, for clarity, the examples below focus primarily on an embodiment in which a user computing device receives a request from a user for navigation directions to a destination location, such as a POI. The user computing device transmits the request to a server device that obtains a set of navigation directions for navigating from the user's current location to the POI along a route. The server device then responds to the request by providing the set of navigation directions to the user computing device for presentation to the user via text and/or audio navigation instructions.

The server device may also identify a website for the POI by crawling the Internet for candidate websites which may correspond to the POI, and identifying the website from the candidate websites by comparing characteristics of the candidate websites to characteristics of the POI. For example, the server device may identify the website with the same name as the POI, with the same address or location as the POI, with the same phone number as the POI, etc. The server device may then extract detailed information about the POI from the POI website, such as store hours for the POI, menu information for the POI, event information at the POI, attractions as the POI, detailed information about the attractions, etc.

In some implementations, the server device may include some of the extracted information in an announcement. For example, the server device may generate an announcement when the extracted information includes new menu items or specials, new events or attractions, events or attractions which are no longer available or temporarily out of service, etc. The server device may then provide the announcement to the user computing device for presentation to the user as the user travels to the POI. For example, the user computing device may present an audio announcement and/or may present the announcement via text, for example on a map display.

Additionally or alternatively, the user computing device may obtain a query from the user regarding the POI as the user travels to the POI. The user computing device may transmit the query to the server device. The server device may then extract information from the POI website to respond to the query. Then the server device may generate and transmit a response to the query that includes obtained web content from the POI website.

### Example Hardware and Software Components

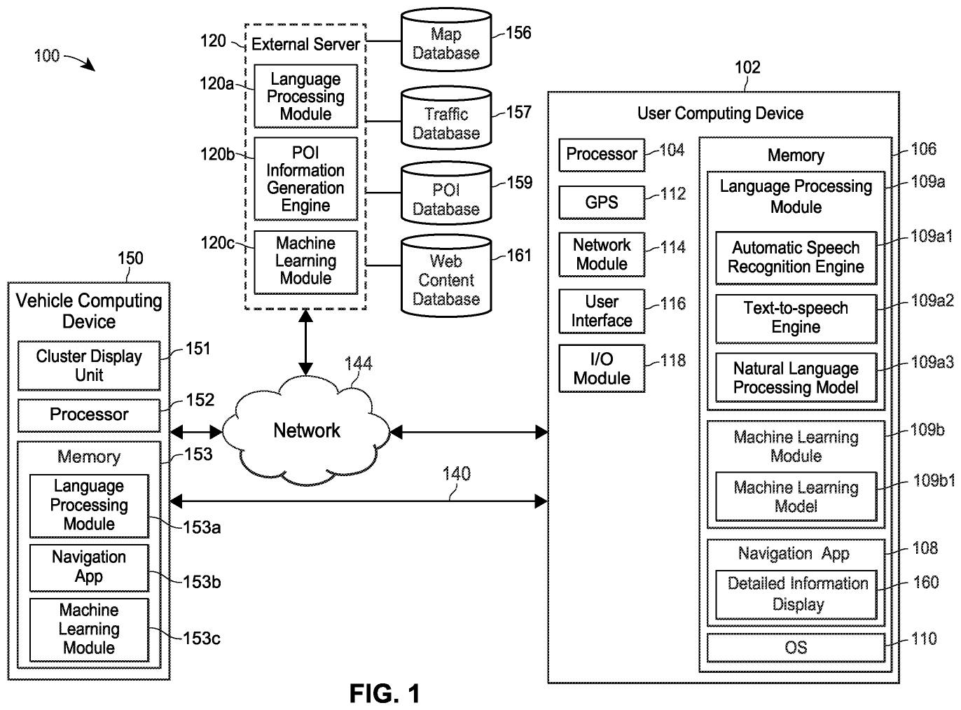

Referring first to FIG. 1, an example communication system 100 in which techniques for providing detailed destination information during a navigation session can be implemented includes a user computing device 102. The user computing device 102 may be a portable device such as a smart phone or a tablet computer, for example. The user computing device 102 may also be a laptop computer, a desktop computer, a personal digital assistant (PDA), a wearable device such as a smart watch or smart glasses, etc. In some embodiments, the user computing device 102 may be removably mounted in a vehicle, embedded into a vehicle, and/or may be capable of interacting with a head unit of a vehicle to provide navigation instructions. In other embodiments, the user computing device 102 is not within a vehicle environment.

The user computing device 102 may include one or more processor(s) 104 and a memory 106 storing machine-readable instructions executable on the processor(s) 104. The processor(s) 104 may include one or more general-purpose processors (e.g., CPUs), and/or special-purpose processing units (e.g., graphical processing units (GPUs)). The memory 106 can be, optionally, a non-transitory memory and can include one or several suitable memory modules, such as random access memory (RAM), read-only memory (ROM), flash memory, other types of persistent memory, etc. The memory 106 may store instructions for implementing a navigation application 108 that can provide navigation directions (e.g., by displaying directions or emitting audio instructions via the user computing device 102), display an interactive digital map, request and receive routing data to provide driving, walking, or other navigation directions, provide various geo-located content such as traffic, points-of-interest (POIs), and weather information, etc.

Further, the memory 106 may include a language processing module 109a configured to implement and/or support the techniques of this disclosure for providing detailed destination information during a navigation session. Namely, the language processing module 109a may include an automatic speech recognition (ASR) engine 109a1 that is configured to transcribe speech inputs from a user into sets of text. Further, the language processing module 109a may include a text-to-speech (TTS) engine 109a2 that is configured to convert text into audio outputs, such as audio requests, navigation instructions, and/or other outputs for the user. In some scenarios, the language processing module 109a may include a natural language processing (NLP) model 109a3 that is configured to output textual transcriptions, intent interpretations, and/or audio outputs related to a speech input received from a user of the user computing device 102. It should be understood that, as described herein, the ASR engine 109a1 and/or the TTS engine 109a2 may be included as part of the NLP model 109a3 in order to transcribe user speech inputs into a set of text, convert text outputs into audio outputs, and/or any other suitable function described herein as part of a conversation between the user computing device 102 and the user.

Generally, the language processing module 109a may include computer-executable instructions for training and operating the NLP model 109a3. In general, the language processing module 109a may train one or more NLP models 109a3 by establishing a network architecture, or topology, and adding layers that may be associated with one or more activation functions (e.g., a rectified linear unit, softmax, etc.), loss functions and/or optimization functions. Such training may generally be performed using a symbolic method, machine learning (ML) models, and/or any other suitable training method. More generally, the language processing module 109a may train the NLP models 109a3 to perform two techniques that enable the user computing device 102, and/or any other suitable device (e.g., vehicle computing device 151) to understand the words spoken by a user and/or words generated by a text-to-speech program (e.g., TTS engine 109a2) executed by the processor 104: syntactic analysis and semantic analysis.

Syntactic analysis generally involves analyzing text using basic grammar rules to identify overall sentence structure, how specific words within sentences are organized, and how the words within sentences are related to one another. Syntactic analysis may include one or more sub-tasks, such as tokenization, part of speech (POS) tagging, parsing, lemmatization and stemming, stop-word removal, and/or any other suitable sub-task or combinations thereof. For example, using syntactic analysis, the NLP model 109a3 may generate textual transcriptions from the speech inputs from the user. Additionally, or alternatively, the NLP model 109a3 may receive such textual transcriptions as a set of text from the ASR engine 109a1 in order to perform semantic analysis on the set of text.

Semantic analysis generally involves analyzing text in order to understand and/or otherwise capture the meaning of the text. In particular, the NLP model 109a3 applying semantic analysis may study the meaning of each individual word contained in a textual transcription in a process known as lexical semantics. Using these individual meanings, the NLP model 109a3 may then examine various combinations of words included in the sentences of the textual transcription to determine one or more contextual meanings of the words. Semantic analysis may include one or more sub-tasks, such as word sense disambiguation, relationship extraction, sentiment analysis, and/or any other suitable sub-tasks or combinations thereof. For example, using semantic analysis, the NLP model 109a3 may generate one or more intent interpretations based on the textual transcriptions from the syntactic analysis.

In these aspects, the language processing module 109a may include an artificial intelligence (AI) trained conversational algorithm (e.g., the natural language processing (NLP) model 109a3) that is configured to interact with a user that is accessing the navigation application 108. The user may be directly connected to the navigation application 108 to provide verbal input/responses (e.g., speech inputs), and/or the user request may include textual inputs/responses that the TTS engine 109a2 (and/or other suitable engine/model/algorithm) may convert to audio inputs/responses for the NLP model 109a3 to interpret. When a user accesses the navigation application 108, the inputs/responses spoken by the user and/or generated by the TTS engine 109a2 (or other suitable algorithm) may be analyzed by the NLP model 109a3 to generate textual transcriptions and intent interpretations.

The language processing module 109a may train the one or more NLP models 109a3 to apply these and/or other NLP techniques using a plurality of training speech inputs from a plurality of users. As a result, the NLP model 109a3 may be configured to output textual transcriptions and intent interpretations corresponding to the textual transcriptions based on the syntactic analysis and semantic analysis of the user's speech inputs.

In certain aspects, one or more types of machine learning (ML) may be employed by the language processing module 109a to train the NLP model(s) 109a3. The ML may be employed by the ML module 109b, which may store a ML model 109b1. The ML model 109b1 may be configured to receive a set of text corresponding to a user input, and to output an intent and destination based on the set of text. The NLP model(s) 109a3 may be and/or include one or more types of ML models, such as the ML model 109b1. More specifically, in these aspects, the NLP model 109a3 may be or include a machine learning model (e.g., a large language model (LLM)) trained by the ML module 109b using one or more training data sets of text in order to output one or more training intents and one or more training destinations, as described further herein. For example, artificial neural networks, recurrent neural networks, deep learning neural networks, a Bayesian model, and/or any other suitable ML model 109b1 may be used to train and/or otherwise implement the NLP model(s) 109a3. In these aspects, training may be performed by iteratively training the NLP model(s) 109a3 using labeled training samples (e.g., training user inputs).

In instances where the NLP model(s) 109a3 is an artificial neural network, training of the NLP model(s) 109a3 may produce byproduct weights, or parameters which may be initialized to random values. The weights may be modified as the network is iteratively trained, by using one of several gradient descent algorithms, to reduce loss and to cause the values output by the network to converge to expected, or “learned”, values. In embodiments, a regression neural network may be selected which lacks an activation function, wherein input data may be normalized by mean centering, to determine loss and quantify the accuracy of outputs. Such normalization may use a mean squared error loss function and mean absolute error. The artificial neural network model may be validated and cross-validated using standard techniques such as hold-out, K-fold, etc. In embodiments, multiple artificial neural networks may be separately trained and operated, and/or separately trained and operated in conjunction.

In embodiments, the one or more NLP models 109a3 may include an artificial neural network having an input layer, one or more hidden layers, and an output layer. Each of the layers in the artificial neural network may include an arbitrary number of neurons. The plurality of layers may chain neurons together linearly and may pass output from one neuron to the next, or may be networked together such that the neurons communicate input and output in a non-linear way. In general, it should be understood that many configurations and/or connections of artificial neural networks are possible. For example, the input layer may correspond to input parameters that are given as full sentences, or that are separated according to word or character (e.g., fixed width) limits. The input layer may correspond to a large number of input parameters (e.g., one million inputs), in some embodiments, and may be analyzed serially or in parallel. Further, various neurons and/or neuron connections within the artificial neural network may be initialized with any number of weights and/or other training parameters. Each of the neurons in the hidden layers may analyze one or more of the input parameters from the input layer, and/or one or more outputs from a previous one or more of the hidden layers, to generate a decision or other output. The output layer may include one or more outputs, each indicating a prediction. In some embodiments and/or scenarios, the output layer includes only a single output.

It is noted that although FIG. 1 illustrates the navigation application 108 as a standalone application, the functionality of the navigation application 108 also can be provided in the form of an online service accessible via a web browser executing on the user computing device 102, as a plug-in or extension for another software application executing on the user computing device 102, etc. The navigation application 108 generally can be provided in different versions for different operating systems. For example, the maker of the user computing device 102 can provide a Software Development Kit (SDK) including the navigation application 108 for the Android™ platform, another SDK for the iOS™ platform, etc.

The memory 106 may also store an operating system (OS) 110, which can be any type of suitable mobile or general-purpose operating system. The user computing device 102 may further include a global positioning system (GPS) 112 or another suitable positioning module, a network module 114, a user interface 116 for displaying map data and directions, and input/output (I/O) module 118. The network module 114 may include one or more communication interfaces such as hardware, software, and/or firmware of an interface for enabling communications via a cellular network, a Wi-Fi network, or any other suitable network such as a network 144, discussed below. The I/O module 118 may include I/O devices capable of receiving inputs from, and providing outputs to, the ambient environment and/or a user. The I/O module 118 may include a touch screen, display, keyboard, mouse, buttons, keys, microphone, speaker, etc. In various implementations, the user computing device 102 can include fewer components than illustrated in FIG. 1 or, conversely, additional components.

The user computing device 102 may communicate with a server device 120 and/or a vehicle computing device 150 via a network 144. The network 144 may include one or more of an Ethernet-based network, a private network, a cellular network, a local area network (LAN), and/or a wide area network (WAN), such as the Internet. The navigation application 108 may transmit map data, navigation directions, and other geo-located content from a map database 156 to the vehicle computing device 150 for display on the cluster display unit 151. Additionally, or alternatively, the navigation application 108 may access map, navigation, and geo-located content that is stored locally at the user computing device 102, and may access the map database 156 periodically to update the local data or during navigation to access real-time information, such as real-time traffic data. Moreover, the user computing device 102 may be directly connected to the vehicle computing device 150 through any suitable direct communication link 140, such as a wired connection (e.g., a USB connection).

In certain aspects, the network 144 may include any communication link suitable for short-range communications and may conform to a communication protocol such as, for example, Bluetooth™ (e.g., BLE), Wi-Fi (e.g., Wi-Fi Direct), NFC, ultrasonic signals, etc. Additionally, or alternatively, the network 144 may be, for example, Wi-Fi, a cellular communication link (e.g., conforming to 3G, 4G, or 5G standards), etc. In some scenarios, the network 144 may also include a wired connection.

The server device 120 may be a remotely located server that includes processing capabilities and executable instructions necessary to perform some/all of the actions described herein with respect to the user computing device 102. For example, the server device 120 may include a language processing module 120a that is similar to the language processing module 109a included as part of the user computing device 102, and the module 120a may include one or more of the ASR engine 109a1, the TTS engine 109a2, and/or the NLP model 109a3. Additionally, the server device 120 may include a POI information generation engine 120b which extracts information from the web content for a particular POI and analyzes the extracted information to respond to queries and provide announcements regarding the particular POI. The server device 120 may also include an ML module 120c that is similar to the ML module 109b included as part of the user computing device 102.

The vehicle computing device 150 includes one or more processor(s) 152 and a memory 153 storing computer-readable instructions executable by the processor(s) 152. The memory 153 may store a language processing module 153a, a navigation application 153b, and a ML module 153c that are similar to the language processing module 153a, the navigation application 108, and the ML module 109b, respectively. The navigation application 153b may support similar functionalities as the navigation application 108 from the vehicle-side and may facilitate rendering of information displays, as described herein. For example, in certain aspects, the user computing device 102 may provide the vehicle computing device 150 with an accepted route that has been accepted by a user, and the corresponding navigation instructions to be provided to the user as part of the accepted route. The navigation application 153b may then proceed to render the navigation instructions within the cluster unit display 151 and/or to generate audio outputs that verbally provide the user with the navigation instructions via the language processing module 153a.

In any event, the server device 120 may be communicatively coupled to various databases, such as a map database 156, a traffic database 157, and a POI database 159, and a web content database 161 (also referred to herein as an “offline database”) from which the server device 120 can retrieve navigation-related data. The map database 156 may include map data such as map tiles, visual maps, road geometry data, road type data, speed limit data, etc. The map database 156 may also include route data for providing navigation directions, such as driving, walking, biking, or public transit directions, for example. The traffic database 157 may store historical traffic information as well as real-time traffic information. The POI database 159 may store descriptions, locations, images, and other information regarding landmarks, places, or other points-of-interest, such as restaurants, bars, hotels, movie theatres, amusement parks, stadiums, concert venues, casinos, museums, parks, bowling alleys, pool halls, pharmacies, grocery stores, banks, department stores, gyms, etc. The web content database 161 may store web content extracted from websites or applications corresponding to the POIs in the POI database 159. The web content may include an entire web page, portions of the web page which include text, or specific types of information for the corresponding POI, such as a list of menu items, menu specials, a list of rides at an amusement park, the operational status of each ride, information describing the ride including suitable ages for the ride, the length or the ride, the speed of the ride, etc., event information for events at the POI, product information for products at the POI, such as products at a pharmacy, grocery store, or department store, equipment information indicating the workout equipment at a gym, casino gaming information indicating the casino games at a casino, etc.

The web content database 161 may be an offline database so that the server device 120 may cache web content from a POI website or application to provide announcements or respond to queries regarding the POI as a user is navigating to the POI. The web content database 161 may include timestamps indicating when the latest web content for a particular POI website or application was obtained so that the server device 120 can retrieve updated web content directly from the particular POI website or application if for example, the web content at the web content database 161 is outdated or the query requires live information. Additionally, the web content database 161 may store the web address where web content was retrieved for each POI or the name of the application. In some implementations, the user computing device 102 and/or the vehicle computing device 150 may alternatively or additionally comprise a web content database with the functionality described above. In some implementations, web content regarding the POI from a website for the POI may be downloaded to a web content database of the user computing device 102 and/or of the vehicle computing device 150. The web content may be downloaded from the server device 120 (e.g., from the web content database 161 thereof), or from the website itself. During the navigation session as the user travels to the POI, the user computing device 102 and/or the vehicle computing device 150 may analyze the web content to identify a subset thereof, and use this to provide a response to a query or to provide an announcement as described herein.

The server device 120 may also periodically (e.g., every hour, every day, every week, etc.) update the web content database 161 by replacing the old web content with updated web content retrieved from the particular POI website or application. In this manner, the web content database 161 may include web content which should be reliable for responding to the vast majority of queries which do not require real-time information.

While FIG. 1 depicts databases 156, 157, 159, and 161, the user computing device 102, the vehicle computing device 150, and/or the server device 120 may be communicatively coupled to additional, or conversely, fewer, databases. For example, the server device 120 may be communicatively coupled to a database storing weather data.

When the user provides a text or audio request for navigation directions to a particular POI via the navigation application 108, the user computing device 102 may provide the request to the server device 120. The user may provide a particular trigger phrase or hot word which causes the navigation application 108 to receive the audio request from the user, such as “Hey Maps.” The user may also provide a particular mode of transportation for the navigation directions, such as driving directions, walking directions, biking directions, public transportation directions, ridesharing directions, etc.

The server device 120 then obtains a set of navigation directions for traveling from the user's current location to the POI, by for example communicating with the map database 156. In addition to obtaining the set of navigation directions, the server device 120, and more specifically, the POI information generation engine 120b may obtain web content from a website or application corresponding to the POI. As used herein, the term “web content” may be used to refer to content from a POI website or content from an application associated with the POI. In some implementations, the POI information generation engine 120b first searches the web content database 161 to determine whether web content for the POI is cached in the offline database 161. If web content is cached in the web content database 161 for the POI, the POI information generation engine 120b determines the freshness of the web content. If the web content has not been updated in more than a threshold period of time, the POI information generation engine 120b may update the web content by retrieving updated web content from the stored web address for the POI website.

If on the other hand, web content for the POI is not cached in the offline database 161, the POI information generation engine 120b crawls the Internet to identify a website or application corresponding to the POI. More specifically, the POI information generation engine 120b may identify a set of candidate websites or applications which may correspond to the POI. For example, if the POI is a chain restaurant named McDowell's, the POI information generation engine 120b may identify a first candidate website as “http://www.mcdowells.com,” a second candidate website as “http://www.mcdowells.com/chicago” specific to a Chicago location, a third candidate website as “http://www.mcdowells.com/sanfrancisco” specific to a San Francisco location, a fourth candidate website as “https://www.mcdowellsfanclub.com,” and a fifth candidate website as “http://mcdowellscompany.com.”

The POI information generation engine 120b may then identify one of the candidate websites or applications as the POI website or application based on characteristics of each candidate website or application, such as a geographic area indicated on the candidate website or application, a place name indicated on the candidate website or application, a phone number indicated on the candidate website or application, a freshness metric for the candidate website or application e, a number of links to the candidate website or application, a recency metric based on the last time the user visited the candidate website or application, etc.

The geographic area may be a street address, neighborhood, city, state, country, etc. presented on the web page for the candidate website or included in the web address. The POI information generation engine 120b may compare the geographic area indicated on the candidate website or application to the geographic area for the POI to determine whether the candidate website corresponds to the POI. For example, if the geographic area indicated on the candidate website or application differs from the geographic area for the POI, the POI information generation engine 120b may discard the candidate website or application from the set. In other implementations, the POI information generation engine 120b may assign a first similarity score to the candidate website or application based on the proximity of the geographic area indicated on the candidate website or application to the geographic area for the POI. The POI information generation engine 120b may assign similarity scores to the candidate website or application for each characteristic and may combine the similarity scores in any suitable manner to generate an overall similarity score for the candidate website or application. Then the POI information generation engine 120b may select the candidate website or application having the highest similarity score as the POI website.

The POI information generation engine 120b may also compare the place name and/or the phone number indicated on the candidate website or application to the place name and/or the phone number for the POI to determine whether the candidate website or application corresponds to the POI. Additionally or alternatively, the POI information generation engine 120b may assign similarity scores to the place name and/or the phone number for the POI based on how closely the place name and/or the phone number indicated on the candidate website or application match the place name and/or the phone number for the POI.

The POI information generation engine 120b may generate the freshness metric for the candidate website or application based on the amount of time since the candidate website or application was last updated. If the candidate website or application has not been updated in several years, the candidate website or application is unlikely to be the current POI website or application. In some implementations, the POI information generation engine 120 uses the freshness metric in computing a similarity score, where candidate websites or applications that have been updated more recently are assigned higher similarity scores.

Furthermore, the POI information generation engine 120b may determine the number of links to the candidate website (also referred to herein as “incoming links”) by crawling the Internet for other websites that link to the candidate website. The number of incoming links to a candidate website may signal the quality, importance, and/or popularity of the candidate website. Accordingly, a candidate website having a large number of incoming links may be more likely to be the POI website than a candidate website which has very few incoming links. In some implementations, the POI information generation engine 120b assigns a similarity score to the incoming links, where candidate websites having more incoming links are assigned higher similarity scores.

The POI information generation engine 120b may determine the recency metric based on the last time the user visited the candidate website or application. Candidate websites or applications visited more recently are assigned higher similarity scores.

As mentioned above, the POI information generation engine 120b may combine the similarity scores for each characteristic in any suitable manner to generate an overall similarity score for the candidate website or application. Then the POI information generation engine 120b may select the candidate website or application having the highest similarity score as the POI website or application.

In any event, the POI information generation engine 120b may then analyze the web content on the selected POI website or application for example, using the natural language processing techniques described above to identify information to include in an announcement which may be provided to the user unprompted without receiving a request for the announcement by the user. For example, the machine learning module 109b/120c may use a classifier to train a machine learning model 109b1 to identify announcement information within web content.

Announcement information may include status information for rides, games, menu items indicating their availability or lack thereof. Announcement information may also include changes to event information, such as changes in scheduled times or postponements for movies, converts, sporting events, etc. Additionally, announcement information may include changes since the user previously visited the POI. The server device 120 may store a user profile for the user which indicates previous visits to the POI. The POI information generation engine 120b may compare the information on the POI website or application to POI information from the last time the user visited the POI. The POI information generation engine 120b may then include new rides, new casino games, new menu items, or any other updates to the POI since the user last visited as announcement information.

In some implementations, the POI information generation engine 120b then includes the announcement information in an announcement and provides the announcement to the navigation application 108, and more specifically, the detailed information display 160 to be presented to the user during the navigation session as the user travels to the POI. The detailed information display 160 may present the announcement as a text announcement on the user interface 116 of the user computing device 102. In other implementations, the detailed information display 160 may present the announcement as an audio announcement via the speakers 118 of the user computing device 102.

In yet other implementations, the POI information generation engine 120b assigns a priority level or metric to each set of announcement information regarding a level of importance of the announcement information. The POI information generation engine 120b may generate an announcement for a set of announcement information having a high priority level or a priority metric above a first threshold priority metric.

The POI information generation engine 120b may not generate announcements for sets of announcement information having medium or low priority levels or priority metrics which do not exceed the first threshold priority metric. Instead, the POI information generation engine 120b may wait to provide a set of announcement information having a low priority level or a priority metric which is below a second threshold priority metric until the user provides a query where the set of announcement information is responsive to the query.

The POI information generation engine 120b also may not provide medium priority level announcement information unprompted (e.g., having a medium priority level or a priority metric which is below the first threshold priority metric but above the second threshold priority metric). However, the POI information generation engine 120b may provide the medium priority level announcement information in response to a query which is not for the medium priority level announcement information but is related to the medium priority level announcement information. For example, if the medium priority level announcement information is related to the same category as the query, the POI information generation engine 120b may provide the medium priority level announcement information in response to a query in addition to other information which is responsive to the query. More specifically, if the user asks for today's specials at a restaurant and the medium priority level announcement information is a new salmon dish which is not a special, the POI information generation engine 120b may generate a response which includes the specials and also announces that there is a new salmon dish.

In addition to generating announcement information, the POI information generation engine 120b responds to queries regarding the POI during the navigation session as the user is traveling to the POI. For example, the user may provide a query via audio or text input to the user computing device 102. The user computing device 102 may then transmit the query to the POI information generation engine 120b or may analyze the query using the language processing module 109a and/or the machine learning module 109b to interpret the query and determine attributes of the query, such as whether the query is for detailed information about the destination or other information (e.g., navigation information), the type of information requested (e.g., menu information, event information, ride information, etc.), etc.

The user computing device 102 and/or the server device 120 may also analyze the query to determine the time sensitivity of the query. For example, if the query is regarding menu items, the user computing device 102 and/or the server device 120 may determine that the menu items are unlikely to change as frequently and may obtain the web content from the offline database 161 to respond to the query. On the other hand, if the query is for today's specials or today's events, the server device 120 may determine that the query is time sensitive and may obtain live or real-time web content from the POI website or application to respond to the query.

In any event, the server device 120 may analyze the web content from the offline database 161 and/or the POI website or application to identify a subset of the web content which is responsive to the query. For example, if the query is for information about a particular ride, the server device 120 may identify the portion of the web content which describes the particular ride. In some scenarios, the server device 120 may search for particular attributes of the ride within the web content. For example, if the query is for information about the speed of the ride, the server device 120 may search the web content for terms similar to “speed.” “velocity.” “fast.” “slow.” “miles per hour,” “acceleration,” etc., which are proximate to the name of the ride in the web content. Then the server device 120 may extract the sentence or paragraph that includes the name of the ride and the identified attribute.

For example, the server device 102 may paraphrase or modify the extracted sentence or paragraph using the natural language processing techniques described above to generate a response to the query. To paraphrase or modify the extracted sentence or paragraph, the server device 120 may utilize the language processing module 109a, and in certain aspects, an LLM (e.g., language model for dialogue applications (LaMDA)) (not shown) included as part of the language processing module 109a. Such an LLM may be conditioned/trained to generate the response text based on characteristics of the response, and/or the LLM may be trained to receive a natural language representation of responses to requests for navigation information as input and to output a set of text representing the audio response based on the characteristics.

Then the server device 120 may provide the response to the user computing device 102. The detailed information display 160 may present the response as a text response on the user interface 116 of the user computing device 102. In other implementations, the detailed information display 160 may present the response as an audio response via the speakers 118 of the user computing device 102.

### Example Detailed POI Information During Navigation Sessions

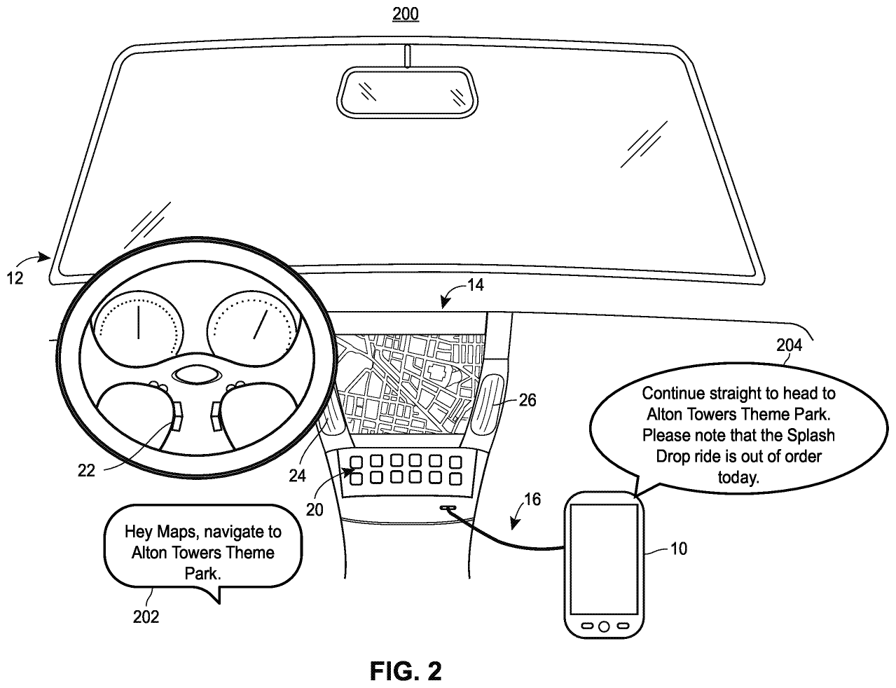

FIGS. 2-7 illustrate example requests for navigation directions to a POI, example announcements regarding information about the POI, example queries for detailed information about the POI, and example responses to the queries. In response to each request for navigation directions, the navigation application 108 initiates a navigation session. Then the navigation application 108 provides announcements and/or responses to queries for detailed information regarding the POI. Detailed information may include any information about the POI which is not related to navigating to the POI. The detailed information may include information about the POI other than the name and address of the POI.

While the example scenarios in FIGS. 2-7 include requests related to driving directions these are merely a few examples for case of illustration only. The detailed information navigation system can be used for any suitable mode of transportation including driving, walking, biking, or public transportation.

Additionally, while the example scenarios described herein are generally in the context of a speech based configuration, the detailed information navigation system can also be used in the context of a touch-based or visual interface. For example, user requests for navigation information can be entered via free-form textual input or through UI elements (e.g. a drop-down menu). Responses to the user requests can be displayed to the user via the user interface. Additionally, user queries for information regarding the POI can be entered via free-form textual input or through UI elements (e.g. a drop-down menu). Announcements or responses to the user queries regarding the POI can be displayed to the user via the user interface. Embodiments disclosed herein that are described in the context of a speech-based interface may also be applied to the context of a touch-based interface. All embodiments disclosed herein in which inputs or outputs are described in the context of a speech-based interface may be adapted to apply to the context of a touch-based interface.

FIG. 2 illustrates an example scenario 200 where a user requests navigation directions to a POI, Alton Towers Theme Park. The user request may be an audio request. More specifically, the user asks, “Hey Maps, navigate to Alton Towers Theme Park” 202. The user may be a driver, a front seat passenger, a back seat passenger in the vehicle 12, etc.

The example vehicle 12 in FIG. 2 includes a client device 10 (which may include the same components and functionality as the user computing device 102) and a head unit 14 (which may include the same components and functionality as the vehicle computing device 150). The client device 10 communicates with the head unit 14 of the vehicle 12 via a communication link 16, which may be wired (e.g., Universal Serial Bus (USB)) or wireless (e.g., Bluetooth, Wi-Fi Direct). The client device 10 also can communicate with various content providers, servers, etc. via a wireless communication network such as a fourth-or third-generation cellular network (4G or 3G, respectively).

The head unit 14 can include a display 18 for presenting navigation information such as a digital map. The display 18 in some implementations is a touchscreen and includes a software keyboard for entering text input, which may include the name or address of a destination, point of origin, etc. Hardware input controls 20 and 22 on the head unit 14 and the steering wheel, respectively, can be used for entering alphanumeric characters or to perform other functions for requesting navigation directions. The head unit 14 also can include audio input and output components such as a microphone 24 and speakers 26, for example. The speakers 26 can be used to play audio instructions or audio announcements sent from the client device 10.

In the example scenario 200, in response to receiving the audio request, the navigation application 108 may communicate with the language processing module 109a, 120a at the user computing device 102 or the external server 120 to interpret the audio request.

More specifically, the user computing device 102 receives the audio request through an input device (e.g., microphone as part of the I/O module 118). The user computing device 102 then utilizes the processor 104 to execute instructions included as part of the language processing module 109a to transcribe the audio request into a set of text. The user computing device 102 may cause the processor 104 to execute instructions comprising, for example, an ASR engine (e.g., ASR engine 109a1) in order to transcribe the audio request from the speech-based input received by the I/O module 118 into the textual transcription of the user input. It should be appreciated that the execution of the ASR engine to transcribe the user input into the textual transcription may be performed by the user computing device 102, the external server 120, the vehicle computing device 150, and/or any other suitable component or combinations thereof.

This transcription of the audio request may then be analyzed, for example, by the processor 104 executing instructions comprising the language processing module 109a and/or the machine learning module 109b to interpret the textual transcription and determine attributes of the request, such as the destination. The user computing device 102 and/or the server device 120 may identify the destination by comparing terms in the audio request to POIs from the POI database 159, addresses included in the map database 156, or predetermined destinations stored in a user profile, such as “Home,” “Work,” “My Office.” etc.

In any event, the server device 120 may then obtain the request for navigation directions to Alton Towers Theme Park from the user computing device. The server device 120 may obtain a set of navigation directions for traveling from the user's current location to Alton Towers Theme Park via the map database 156.

The server device 120 also may obtain web content from a website corresponding to Alton Towers Theme Park. In some implementations, the POI information generation engine 120b first searches the web content database 161 to determine whether web content for Alton Towers Theme Park is cached in the offline database 161. If web content is cached in the web content database 161 for Alton Towers Theme Park, the POI information generation engine 120b determines the freshness of the web content. If the web content has not been updated in more than a threshold period of time, the POI information generation engine 120b may update the web content by retrieving updated web content from the stored web address for the POI website. If on the other hand, web content for the POI is not cached in the offline database 161, the POI information generation engine 120b crawls the Internet to identify a website corresponding to Alton Towers Theme Park.

In any event, the POI information generation engine 120b then analyzes the obtained web content for Alton Towers Theme Park to identify announcement information included in the web content. In the example scenario 200, the POI information generation engine 120b determines that the Splash Drop ride is out of order. The POI information generation engine 120b may also assign a priority level or metric to the announcement information, and in this case, the POI information generation engine 120b assigns a high priority level to the announcement information.

The POI information generation engine 120b then includes the announcement information in an announcement and provides the announcement to the navigation application 108 along with the set of navigation directions.

Accordingly, the detailed information display 160 generates a response 204 including an initial navigation instruction to begin traveling to the destination (“Continue straight to head to Alton Towers Theme Park”), and the announcement (“Please note that the Splash Drop ride is out of order today”). The detailed information display 160 may then provide the response 204 to the user's request for navigation information as an audio output via a speaker, as a visual output on the user interface 116 and/or as a combination of audio/visual output. The detailed information display 160 may provide the announcement at the beginning of the navigation session, near the end of the navigation session as the user approaches the destination, or at any other suitable time during the navigation session.

The user computing device 102 may generate the text of the response 204 by utilizing the language processing module 109a, and in certain aspects, an LLM included as part of the language processing module 109a. Such an LLM may be conditioned/trained to generate the response text based on characteristics of the response, and/or the LLM may be trained to receive a natural language representation of responses to requests for navigation information as input and to output a set of text representing the audio response based on the characteristics.

In any event, when the user computing device 102 fully generates the text of the response 204, the device 102 may proceed to synthesize the text into speech for audio output of the request to the user. In particular, the user computing device 102 may transmit the text of the response 204 to a TTS engine (e.g., TTS engine 109a2) in order to audibly output the response 204 through a speaker (e.g., speaker 26), so that the user may hear and interpret the response. Additionally, or alternatively, the user computing device 102 may also visually prompt the user by displaying the text of the response on a display screen (e.g., cluster display unit 151, user interface 116), so that the user may interact (e.g., click, tap, swipe, etc.) with the display screen and/or verbally acknowledge the response 204.

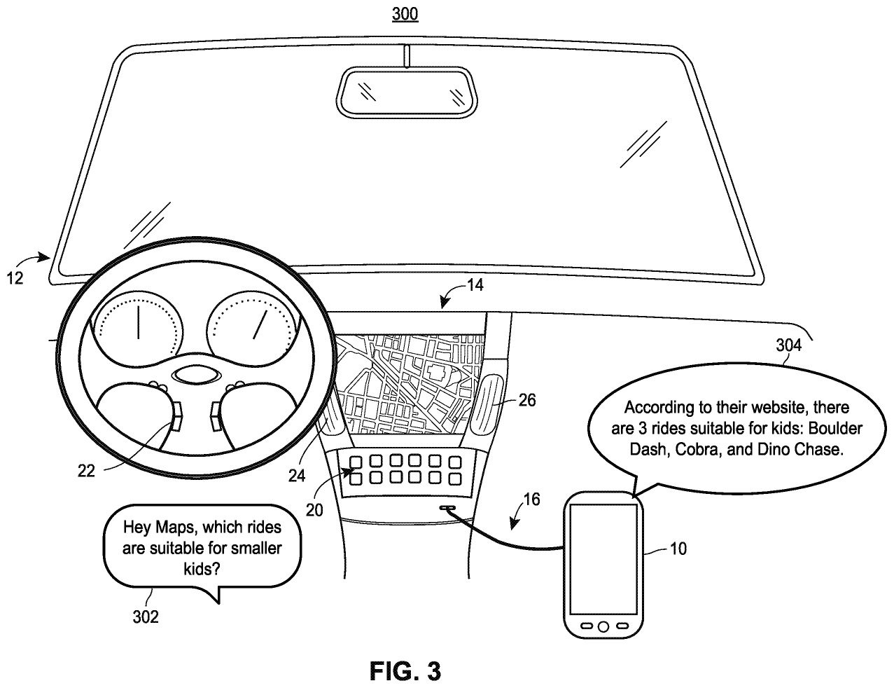

In another example scenario 300 as shown in FIG. 3, a user provides a query 302 for additional information about Alton Towers Theme Park during the navigation session as the user navigates to Alton Towers Theme Park. More specifically, the user asks, “Hey Maps, which rides are suitable for smaller kids?” 302. While the user does not include the name of the POI in the query 302, the navigation application 108 and/or the POI information generation engine 120b, infers that the query 302 is for Alton Towers Theme Park because it is the destination.

In addition to inferring the POI in the user's query 302 for detailed information, the language processing module 109a may identify other attributes of the user's query 302. For example, the language processing module 109a may identify the type of query 302, such as ride information. The language processing module 109a may also identify specific parameters within the query 302, such as “kids.”

The language processing module 109a may also analyze the query 302 to determine the time sensitivity of the query. In this instance, ride information is unlikely to change frequently, and the POI information generation engine 120b may obtain the web content from the offline database 161 to respond to the query 302. In some instances, the POI information generation engine 120b determines when the web content for Alton Towers Theme Park was last updated in the offline database 161. If the web content has not been updated in more than a threshold period of time (e.g., a day, a week, a month, etc.), the POI information generation engine 120b may update the web content by retrieving an updated version from the Alton Towers Theme Park website.

In any event, the POI information generation engine 120b and/or the language processing module 109a may analyze the web content from the offline database 161 and/or the Alton Towers Theme Park website to identify a subset of the web content which is responsive to the query 302 using the natural language processing techniques described above. For example, the language processing module 109a identifies a subset of the web content which includes ride information for the rides, such as a list of rides, ride attributes such as the length of the rides, speed of the rides, etc. Then the language processing module 109a may filter the subset to only include ride information for rides indicated as suitable for children. For example, the web content may include three rides which are designated for kids: Boulder Dash, Cobra, and Dino Chase.

The POI information generation engine 120b then includes the filtered subset of web content in a response 304 (“According to their website, there are 3 rides suitable for kids: Boulder Dash, Cobra, and Dino Chase”) to the query 302 and provides the response 304 to the navigation application 108.

Accordingly, the detailed information display 160 provides the response 304 to the user's query 302 as an audio output via a speaker, as a visual output on the user interface 116 and/or as a combination of audio/visual output.

The server device 120 and/or the user computing device 102 may generate the text of the response 304 by utilizing the language processing module 109a, and in certain aspects, an LLM included as part of the language processing module 109a. Such an LLM may be conditioned/trained to generate the response text based on characteristics of the response, and/or the LLM may be trained to receive a natural language representation of responses to requests for navigation information as input and to output a set of text representing the audio response based on the characteristics.

In any event, when the server device 120 and/or the user computing device 102 fully generates the text of the response 304, the device 102 may proceed to synthesize the text into speech for audio output of the request to the user. In particular, the user computing device 102 may transmit the text of the response 304 to a TTS engine (e.g., TTS engine 109a2) in order to audibly output the response 304 through a speaker (e.g., speaker 26), so that the user may hear and interpret the response. Additionally, or alternatively, the user computing device 102 may also visually prompt the user by displaying the text of the response 304 on a display screen (e.g., cluster display unit 151, user interface 116), so that the user may interact (e.g., click, tap, swipe, etc.) with the display screen and/or verbally acknowledge the response 304.

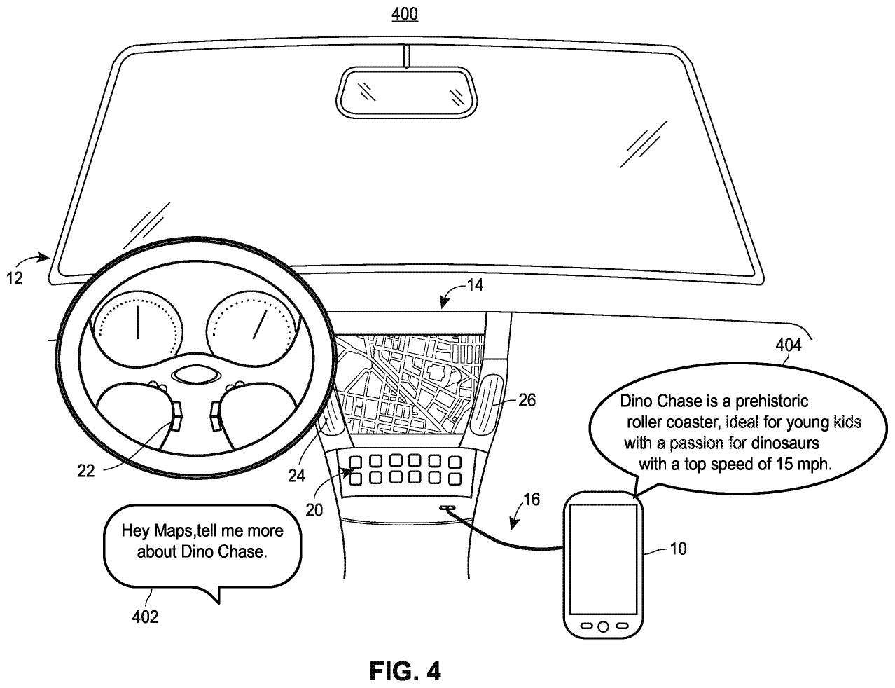

In some scenarios, the user may provide a follow up question to the response 304. For example, in the example scenario 400 as shown in FIG. 4, after receiving the response indicating that the rides suitable for kids are Boulder Dash, Cobra, and Dino Chase, the user provides an additional query 402 for more information about Dino Chase. More specifically, the user asks, “Hey Maps, tell me more about Dino Chase” 402.

The POI information generation engine 120b and/or the language processing module 109a may then analyze the web content from the offline database 161 and/or the Alton Towers Theme Park website once again to identify a subset of the web content which is responsive to the query 402 using the natural language processing techniques described above. For example, the language processing module 109a identifies a subset of the web content which includes ride information for Dino Chase, such as the type of ride, the theme of the ride, the length of the ride, the speed of the ride, etc.

The POI information generation engine 120b then includes the subset of web content in a response 404 (“Dino Chase is a prehistoric roller coaster, ideal for young kids with a passion for dinosaurs with a top speed of 15 mph”) to the query 402 and provides the response 404 to the navigation application 108.

Accordingly, the detailed information display 160 provides the response 404 to the user's query 402 as an audio output via a speaker, as a visual output on the user interface 116 and/or as a combination of audio/visual output.

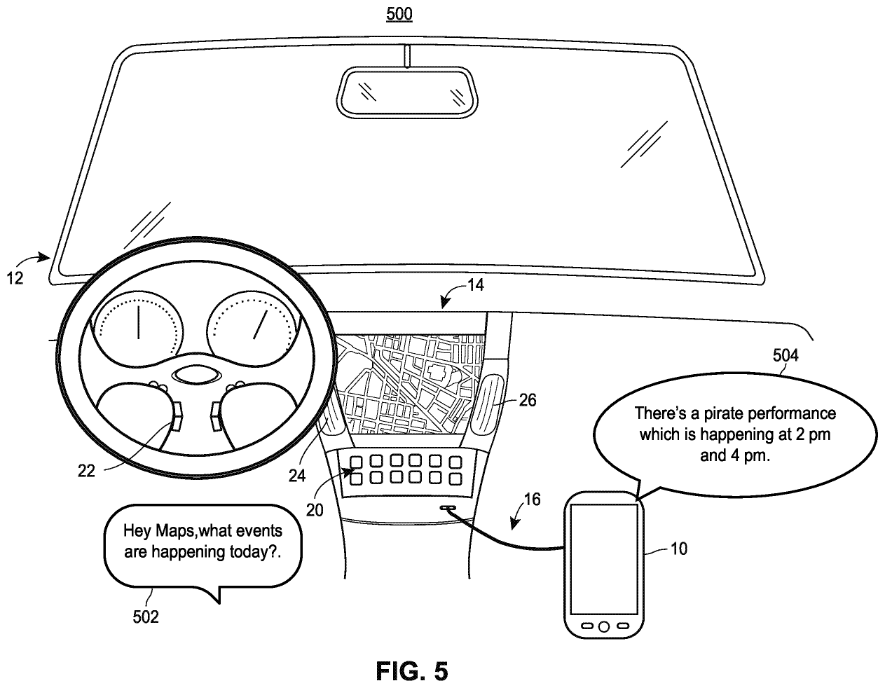

In some scenarios, the user may provide a query for time sensitive, real-time, and/or live information. For example, the user may provide a query for information regarding the POI which changes or is likely to change on a frequent basis, such as hourly, daily, weekly, monthly, etc. This may include event information for events, status information for rides, games, special or seasonal menu items indicating their availability or lack thereof, offer information for limited offers, etc. In the example scenario 500 as shown in FIG. 5, the user provides a query 502 for information about events occurring at Alton Towers Theme Park. More specifically, the user asks, “Hey Maps, what events are happening today” 502. Terms indicating a time component like “today,” “this week.” “tonight.” “this afternoon,” “at 1 p.m.” etc., may indicate that the query is for time sensitive, real-time, and/or live information.

In this case, the POI information generation engine 120b retrieves updated web content directly from the Alton Towers Theme Park website without using the web content from the offline database 161. The POI information generation engine 120b and/or the language processing module 109a may then analyze the web content from the Alton Towers Theme Park website to identify a subset of the web content which is responsive to the query 502 using the natural language processing techniques described above. For example, the language processing module 109a identifies a subset of the web content which includes event information for events at the Alton Towers Theme Park. The event information may include a name of each event at the Alton Towers Theme Park, the time(s) for each event, the length of each event, a description of each event, a description of the event performers, an indication of the suitable age for each event, etc. The language processing module 109a may then filter the subset to only include event information for that day, since the query 502 is for event information on the particular day.

The POI information generation engine 120b then includes the filtered subset of web content in a response 504 (“There's a pirate performance which is happening at 2 pm and 4 pm”) to the query 502 and provides the response 504 to the navigation application 108.

Accordingly, the detailed information display 160 provides the response 504 to the user's query 502 as an audio output via a speaker, as a visual output on the user interface 116 and/or as a combination of audio/visual output.

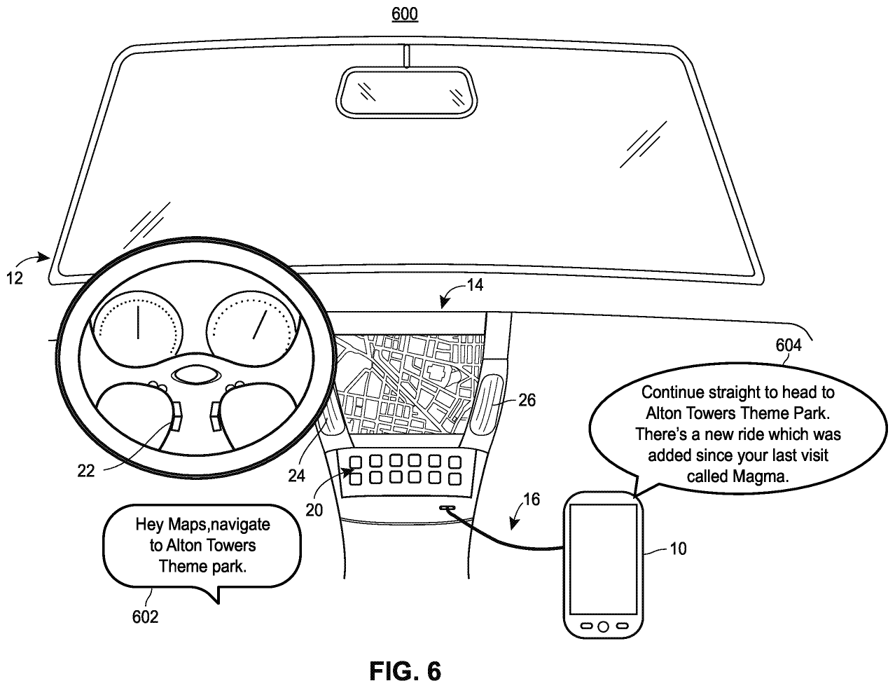

In some scenarios, when the user provides a request for navigation directions to a POI, the server device 120 may identify announcement information indicating changes since the user previously visited the POI. In the example scenario 600 as shown in FIG. 6, the user requests navigation directions to a POI, Alton Towers Theme Park. More specifically, the user asks, “Hey Maps, navigate to Alton Towers Theme Park” 602.

As mentioned above in the example scenario 200, the server device 120 may then obtain the request for navigation directions to Alton Towers Theme Park from the user computing device 102. The server device 120 may obtain a set of navigation directions for traveling from the user's current location to Alton Towers Theme Park via the map database 156.

The server device 120 also may obtain web content from a website corresponding to Alton Towers Theme Park. The POI information generation engine 120b may obtain the web content from the offline database 161 or the Alton Towers Theme Park website.

The POI information generation engine 120b and/or the language processing module 109a then analyzes the obtained web content for Alton Towers Theme Park to identify announcement information included in the web content. Additionally, the server device 120 may store a user profile for the user which indicates previous visits to Alton Towers Theme Park. The POI information generation engine 120b may compare the information from the web content to POI information from the last time the user visited the Alton Towers Theme Park. For example, the offline database 161 may store an older version of the web content from the last time the user visited the Alton Towers Theme Park. In other implementations, the POI information generation engine 120b may search an Internet archive for a version of the web content from the last time the user visited the Alton Towers Theme Park. The POI information generation engine 120b may then compare the information included in the current web content to the information from the version of the web content from the last time the user visited the Alton Towers Theme Park. The POI information generation engine 120b may then include new rides, new casino games, new menu items, or any other updates to the POI since the user last visited as announcement information.

For example, the POI information generation engine 120b may determine that the Magma ride was not included in the list of rides on the Alton Towers Theme Park website the last time the user visited. The POI information generation engine 120b then includes the announcement information describing the new ride in an announcement and provides the announcement to the navigation application 108 along with the set of navigation directions.

Accordingly, the detailed information display 160 generates a response 604 including an initial navigation instruction to begin traveling to the destination (“Continue straight to head to Alton Towers Theme Park”), and the announcement (“There's a new ride which was added since your last visit called Magma”). The detailed information display 160 provides the response 604 to the request for navigation directions 602 as an audio output via a speaker, as a visual output on the user interface 116 and/or as a combination of audio/visual output.

As mentioned above, the POI information generation engine 120b may assign priority levels or metrics to sets of announcement information, such as a high, medium, or low priority level. Then the POI information generation engine 120b may generate and provide an announcement to the navigation application when the priority level or metric for a set of announcement information is above a threshold. In some scenarios, when the priority level or metric is below the threshold, the POI information generation engine 120b may not generate an announcement. Instead, the POI information generation engine 120b may provide the announcement information in response to a query from the user.

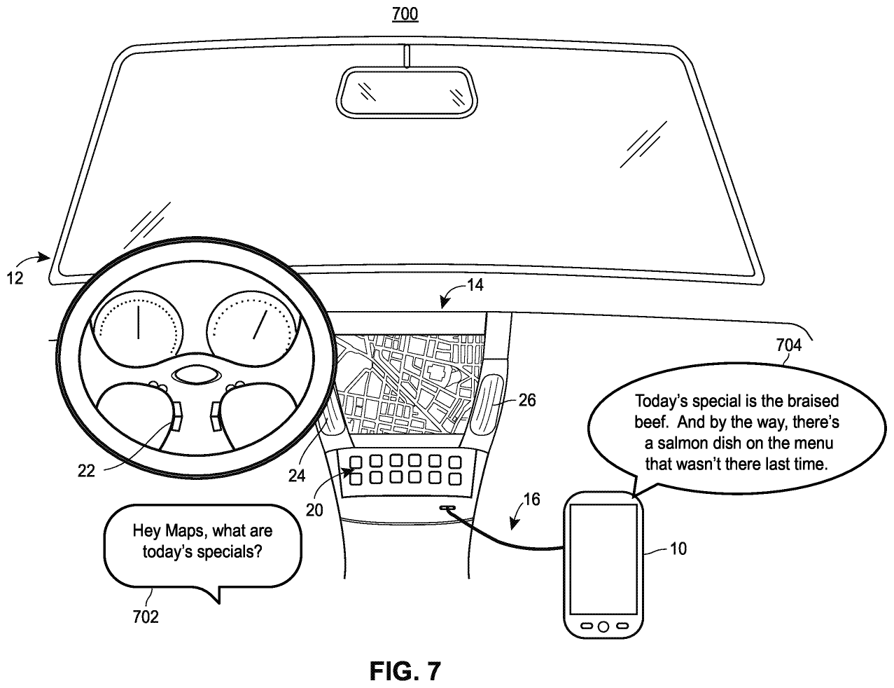

For example, the POI information generation engine 120b may provide medium priority level announcement information in response to a query which is related to the same category as the medium priority level announcement information. In the example scenario 700 as shown in FIG. 7, the user asks, “Hey Maps, what are today's specials” 702. The navigation application 108 and/or the POI information generation engine 120b, infers that the query 702 is for the restaurant which is the user's destination.

The POI information generation engine 120b also determines that there is stored announcement information for the restaurant having a medium priority level indicating that there is a salmon dish on the menu that was not there the last time the user visited the restaurant. The announcement information may have been obtained when the user requested navigation directions to the restaurant and stored for later retrieval when the announcement information was not assigned a high priority level. The language processing module 109a may analyze the query 702 to determine the category for the query 702, which may be menu items. The POI information generation engine 120b may then determine whether the category for the query 702 matches the category for the announcement information.

In response to determining that the announcement information is in the same category as the query 702, the POI information generation engine 120b may include the announcement information along with the response to the query 702. For example, the language processing module 109a identifies a subset of the web content which includes the daily specials.

The POI information generation engine 120b then includes the subset of the web content and the announcement information in a response 704 (“Today's special is the braised beef. And by the way, there's a salmon dish on the menu that wasn't there last time”) to the query 702 and provides the response 704 to the navigation application 108.

Accordingly, the detailed information display 160 provides the response 704 to the user's query 702 as an audio output via a speaker, as a visual output on the user interface 116 and/or as a combination of audio/visual output.

### Example Flow Diagram for Providing Detailed Destination Information During a Navigation Session

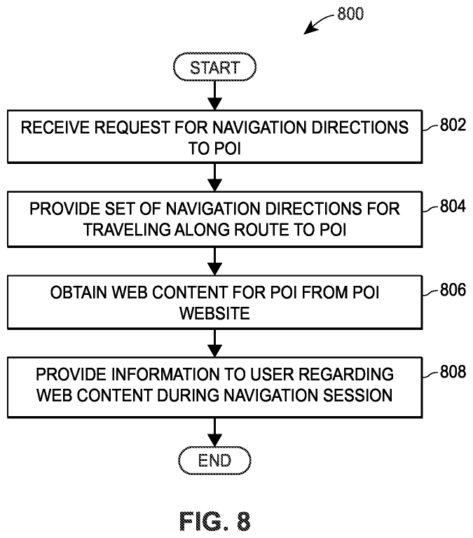

FIG. 8 is a flow diagram of an example method 800 for providing detailed destination information during a navigation session, which can be implemented in a computing device, such as the server device 120 of FIG. 1. The method 800 can be implemented in a set of instructions stored on a computer-readable memory and executable at one or more processors of the server device 120.

It is to be understood that, throughout the description of FIG. 8, actions described as being performed by the server device 120 may, in some implementations, be performed by the user computing device 102, the vehicle computing device 150, and/or may be performed by the user computing device 102, the server device 120, and/or the vehicle computing device 150 in parallel. For example, the user computing device 102, the server device 120, and/or the vehicle computing device 150 may utilize the language processing module 109a, 120a, 153a and/or the machine learning module 109b, 120c, 153c to provide detailed destination information.

At block 802, a request for navigation directions to a POI is received. For example, the user may provide the request to the user computing device 102 via the navigation application 108, which may transmit the request to the server device 120.

Then in response to the request, a set of navigation directions for traveling along a route to the POI are provided for display to the user in a navigation session (block 804). The server device 120 may obtain the set of navigation directions for example, from the map database 156. Then the server device 120 may provide the set of navigation directions to the navigation application 108. The navigation application 108 may then present the navigation directions in a navigation session on the user interface 116 or as audio navigation instructions via a speaker.

Additionally, web content is obtained for the POI from a POI website or application (block 806). In some implementations, the server device 120 first searches the web content database 161 to determine whether web content for the POI is cached in the offline database 161. If web content is cached in the web content database 161 for the POI, the server device 120 determines the freshness of the web content. If the web content has not been updated in more than a threshold period of time, the server device 120 may update the web content by retrieving updated web content from the stored web address for the POI website or application.

If on the other hand, web content for the POI is not cached in the offline database 161, the server device 120 crawls the Internet to identify a website or application corresponding to the POI. More specifically, the server device 120 may identify a set of candidate websites or applications which may correspond to the POI. The server device 120 may then identify one of the candidate websites or applications as the POI website or application based on characteristics of each candidate website or application, such as a geographic area indicated on the candidate website or application, a place name indicated on the candidate website or application, a phone number indicated on the candidate website or application, a freshness metric for the candidate website or application, a number of links to the candidate website or application, etc.

Then, during the navigation session as the user travels to the POI, information is provided to the user regarding the web content (block 808). The information may be provided to the user unprompted as part of an announcement, or may be provided in response to a query by the user for information regarding the POI.

In some implementations, the server device 120 then analyzes the web content for example, using the natural language processing techniques described above to identify information to include in an announcement. For example, the machine learning module 109b/120c may use a classifier to train a machine learning model 109b1 to identify announcement information within web content.

Announcement information may include status information for rides, games, menu items indicating their availability or lack thereof. Announcement information may also include changes to event information, such as changes in scheduled times or postponements for movies, converts, sporting events, etc. Additionally, announcement information may include changes since the user previously visited the POI.

In some implementations, the server device 120 includes the announcement information in an announcement and provides the announcement to the navigation application 108, and more specifically, the detailed information display 160 to be presented to the user during the navigation session as the user travels to the POI. The detailed information display 160 may present the announcement as a text announcement on the user interface 116 of the user computing device 102. In other implementations, the detailed information display 160 may present the announcement as an audio announcement via the speakers 118 of the user computing device 102.

To respond to a query, the server device 120 may analyze the query using the language processing module 109a and/or the machine learning module 109b to interpret the query and determine attributes of the query, such as the type of information requested (e.g., menu information, event information, ride information, etc.).

Then the server device 120 may analyze the web content from the offline database 161 and/or the POI website to identify a subset of the web content which is responsive to the query. Then the server device 120 may extract the sentence or paragraph that includes information responsive to the query.

The server device 120 may then generate a response to the query including the information included in the identified subset of the web content. For example, the server device 102 may paraphrase or modify the extracted sentence or paragraph using the natural language processing techniques described above. To paraphrase or modify the extracted sentence or paragraph, the server device 120 may utilize the language processing module 109a, and in certain aspects, an LLM included as part of the language processing module 109a. Such an LLM may be conditioned/trained to generate the response text based on characteristics of the response, and/or the LLM may be trained to receive a natural language representation of responses to requests for navigation information as input and to output a set of text representing the audio response based on the characteristics.

Then the server device 120 may provide the response to the user computing device 102. The detailed information display 160 may present the response as a text response on the user interface 116 of the user computing device 102. In other implementations, the detailed information display 160 may present the response as an audio response via the speakers 118 of the user computing device 102.

### Additional Considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. As used herein “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The method 800 may include one or more function blocks, modules, individual functions or routines in the form of tangible computer-executable instructions that are stored in a computer-readable storage medium, optionally a non-transitory computer-readable storage medium, and executed using a processor of a computing device (e.g., a server device, a personal computer, a smart phone, a tablet computer, a smart watch, a mobile computing device, or other client computing device, as described herein). The method 800 may be included as part of any backend server (e.g., a map data server, a navigation server, or any other type of server computing device, as described herein), client computing device modules of the example environment, for example, or as part of a module that is external to such an environment. Though the figures may be described with reference to the other figures for case of explanation, the method 800 can be utilized with other objects and user interfaces. Furthermore, although the explanation above describes steps of the method 800 being performed by specific devices (such as a server device), this is done for illustration purposes only. The blocks of the method 800 may be performed by one or more devices or other parts of the environment.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, as indicated above, at least some of the operations may be performed by a group of computers (as examples of machines including processors), these operations being accessible via a network (e.g., the Internet) and via one or more appropriate interfaces (e.g., APIs).

Still further, the figures depict some embodiments of the example environment for purposes of illustration only. One skilled in the art will readily recognize from the following discussion that alternative embodiments of the structures and methods illustrated herein may be employed without departing from the principles described herein.

Upon reading this disclosure, those of skill in the art will appreciate still additional alternative structural and functional designs for providing detailed destination information during a navigation session through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A method for providing detailed destination information during a navigation session, the method comprising:
receiving, at one or more processors, a request for navigation directions to a point of interest (POI);
providing, by the one or more processors for display to a user in a navigation session, a set of navigation directions for traveling along a route to the POI;
obtaining, by the one or more processors, web content regarding the POI from a website for the POI; and
during the navigation session as the user travels to the POI, providing, by the one or more processors, information to the user regarding the obtained web content.

2. The method of claim 1, wherein obtaining web content regarding the POI includes:
crawling, by the one or more processors, Internet websites to identify one or more candidate websites corresponding to the POI; and
identifying, by the one or more processors, one of the one or more candidate websites as the website for the POI based on one or more characteristics of each candidate website.

3. The method of claim 2, wherein the one or more characteristics of each candidate website includes one or more of:
a geographical area indicated on the candidate website;
a place name indicated on the candidate website;
a phone number indicated on the candidate website;
a freshness metric for the candidate website; or
a number of links to the candidate website.

4. The method of claim 1, further comprising:
caching, by the one or more processors, the web content regarding the POI in a web content database.

5. The method of claim 1, wherein obtaining the web content includes:
periodically obtaining, by the one or more processors, updated web content from the POI website.

6. The method of claim 1, wherein providing information to the user regarding the obtained web content includes:
receiving, by the one or more processors, a query from the user regarding the POI;
analyzing, by the one or more processors, the obtained web content to identify a subset of the obtained web content which is responsive to the query; and
providing, by the one or more processors, a response to the query including information from the identified subset of the obtained web content.

7. The method of claim 1, wherein providing information to the user regarding the obtained web content includes:
providing, by the one or more processors, an announcement to the user regarding the obtained web content without receiving a request for the announcement by the user.

8. The method of claim 7, further comprising:
analyzing, by the one or more processors, the obtained web content to identify one or more announcements included in the web content; and
assigning, by the one or more processors, a priority metric to each of the one or more announcements regarding a level of importance of the announcement.

9. The method of claim 8, further comprising:
in response to determining that the priority metric for at least one of the one or more announcements exceeds a threshold priority metric, providing, by the one or more processors, the announcement to the user without receiving the request for the announcement by the user.

10. The method of claim 8, further comprising:
in response to determining that the priority metric for at least one of the one or more announcements does not exceed a threshold priority metric, providing, by the one or more processors, the announcement to the user only in response to the user providing a query regarding the POI.

11. A computing device for providing detailed destination information during a navigation session, the computing device comprising:
one or more processors; and
a computer-readable memory coupled to the one or more processors and storing instructions thereon that, when executed by the one or more processors, cause the computing device to:
provide, for display to a user in a navigation session, a set of navigation directions for traveling along a route to a point of interest (POI);
obtain web content regarding the POI from a website for the POI; and
during the navigation session as the user travels to the POI, provide information to the user regarding the obtained web content.

12. The computing device of claim 11, wherein to obtain web content regarding the POI, the instructions cause the computing device to:
crawl Internet websites to identify one or more candidate websites corresponding to the POI; and
identify one of the one or more candidate websites as the website for the POI based on one or more characteristics of each candidate website.

13. The computing device of claim 12, wherein the one or more characteristics of each candidate website includes one or more of:
a geographical area indicated on the candidate website;
a place name indicated on the candidate website;
a phone number indicated on the candidate website;
a freshness metric for the candidate website; or
a number of links to the candidate website.

14. The computing device of claim 11, wherein the instructions cause the computing device to:
cache the web content regarding the POI in a web content database.

15. The computing device of claim 11, wherein to obtain the web content, the instructions cause the computing device to:
periodically obtain updated web content from the POI website.

16. The computing device of claim 11, wherein to provide information to the user regarding the obtained web content, the instructions cause the computing device to:
receive a query from the user regarding the POI;
analyze the obtained web content to identify a subset of the obtained web content which is responsive to the query; and
provide a response to the query including information from the identified subset of the obtained web content.

17. A computer-readable medium storing instructions thereon, that when executed by one or more processors cause the one or more processors to:
provide, for display to a user in a navigation session, a set of navigation directions for traveling along a route to a point of interest (POI);
obtain web content regarding the POI from a website for the POI; and
during the navigation session as the user travels to the POI, provide information to the user regarding the obtained web content.

18. The computer-readable medium of claim 17, wherein to obtain web content regarding the POI, the instructions cause the one or more processors to:
crawl Internet websites to identify one or more candidate websites corresponding to the POI; and
identify one of the one or more candidate websites as the website for the POI based on one or more characteristics of each candidate website.

19. The computer-readable medium of claim 18, wherein the one or more characteristics of each candidate website includes one or more of:
a geographical area indicated on the candidate website;
a place name indicated on the candidate website;
a phone number indicated on the candidate website;
a freshness metric for the candidate website; or
a number of links to the candidate website.

20. The computer-readable medium of claim 17, wherein the instructions cause the one or more processors to:
cache the web content regarding the POI in a web content database.
